(19) United States
(12) Patent Application Publication
(10) Pub. No.: US 2005/0071518 A1
(43) Pub. Date: Mar. 31, 2005

(54) Flag value renaming

(75) Inventors: Nicholas G. Samra, Austin, TX (US); Stephan J. Jourdan, Portland, OR (US); Jonathan D. Combs, Austin, TX (US); Avinash Sodani, Hillsboro, OR (US); Per H. Hammarlund, Hillsboro, OR (US); Michael P. Cornaby, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 10/677,039

(22) Filed: Sep. 30, 2003

(51) Int. Cl. G06F 3/00

(52) U.S. Cl. 710/1

(57) ABSTRACT

According to an embodiment of the invention, a method and apparatus for flag value renaming. An embodiment of a method comprises setting a flag for a processor via a first instruction, the first instruction being either a direct update instruction or an indirect update instruction; if the setting of the flag is by a direct update instruction, executing a succeeding second instruction that reads the flag prior to completion of the first instruction; and if the setting of the flag is by an indirect update instruction, delaying the second instruction until after completion of the first instruction.

### FIELD

An embodiment of the invention relates to computer operation in general, and more specifically to flag value renaming.

### BACKGROUND

Most computer architectures contain some type of flag register that contains a set of switches to control the operation of the machine. For example, an interrupt flag bit (IF bit) in a machine register may control whether or not interrupts are enabled in the machine.

A register renamer (referred to an a “renamer” herein) may rename logical registers onto a processor's physical register file. The renaming process may allow a smaller, architecturally defined register file to be dynamically expanded to use a larger number of physical registers available in a processor. Renaming may be utilized to eliminate conflicts caused by multiple instructions creating simultaneous but unique versions of a register. A processor pipeline may include many different instances of a register at one time.

However, complications may arise in the naming of certain flags. In certain instances, a flag may be set or cleared not only from an instruction, but also from the data path of a machine. For example, an IF bit may be set according to data loaded from memory, while a clear interrupt flag (CLI) instruction clears the IF flag. In conventional systems, a flag may therefore be non-renamed, thereby requiring serialization and delay to order any writes and reads. In the alternative, a flag may be fully renamed, which may require excessive hardware.

### BRIEF DESCRIPTION OF THE DRAWINGS

The invention may be best understood by referring to the following description and accompanying drawings that are used to illustrate embodiments of the invention. In the drawings:

FIG. 1 illustrates an embodiment of a register receiving flag values from multiple sources;

FIG. 2 illustrates an embodiment of a renaming architecture;

FIG. 3 is a flow chart for an embodiment of the invention;

FIG. 4 illustrates an embodiment of a processor; and

FIG. 5 illustrates an embodiment of a computer environment.

### DETAILED DESCRIPTION

A method and apparatus are described for flag value renaming.

Under an embodiment of the invention, renaming of a flag register occurs without stalling all succeeding instructions to determine when there is a change in value of a flag value. According to the embodiment, stalling or delay of instructions is limited to instances in which the value of a flag is not known. If an instruction sets or clears a flag bit, then succeeding instructions utilizing the flag can proceed because the value of the flag bit is known. Delay may occur when the flag bit is set from a value from memory because the value of the flag bit is not known until the value is stored.

Flag value renaming is a mechanism that allows for the tracking of flag values. There may be multiple sources of flag values. Flag values may be set or cleared by either an instruction that writes a value directly to the register, a direct write, or by data that is obtained from the data path of the machine, an indirect write. Under an embodiment of the invention, the setting of register values is accomplished by effectively executing the direct set or clear instructions at rename time. The register values for instructions that update the flags from the data path are updated at retirement. In a particular embodiment, in order to avoid hazards connected with inconsistent register values, scoreboarding may be used to serialize flag reads and writes.

In one possible example, control flags to be set may include the IF (interrupt flag) register and the DF (direction flag, indicating whether values are incremented or decremented) register bits of the eflags register for the IA-32 micro-architecture. The flags may be updated from two different types of instructions. Direct update instructions can directly set or clear the appropriate flag. For example, direct update instructions may include:
STI—set interrupt flag;
CLI—clear interrupt flag;
STD—set direction flag; and
CLD—clear direction flag.

In contrast, an indirect update instruction reads data from the system data path and updates a flag value based upon that data. For example, “popf” may obtain (or pop) a value from a memory stack and provide such value to the eflags register, and thus a flag may be updated from the obtained data.

Under an embodiment of the invention, a register scoreboard is used to maintain the operation of registers. The register scoreboard may be utilized to maintain register coherency by preventing parallel execution units from accessing a register if an outstanding operation is currently utilizing the register. When an instruction that targets a particular register is executed, the processor may set a scoreboard bit to indicate that the register is being used in an operation. If a succeeding instruction requires the use of the register while the register is in use, as indicated by the scoreboard, then the instruction may be delayed until completion of the prior instruction. If a succeeding instruction does not require data from a register that is in use, the processor may execute the instructions before the prior instruction has completed execution. If an instruction is stalled, later instructions may be issued and executed if the later instructions do not depend on any active or stalled instruction.

According to an embodiment of the invention, direct update instructions are effectively “executed” at the renamer by storing the correct data value in the renamer. In one example, an STI instruction to set the interrupt flag would store a value of “1” (enable) in the IF bit in the renamer. Any instruction that needs to access the value of IF would read the value from the renamer at rename time. A direct update instruction that is addressing a register will check the scoreboard to determine if the register is in use. If the scoreboard bit for the register is set, the instruction stalls until the scoreboard bit is cleared.

Indirect update instructions set a scoreboard bit in the renamer and are processed through the machine normally. For example, if a popf instruction writes to IF the data is stored in the ROB (re-order buffer). When the popf retires, this value is written into the renamer and is available for future instructions that need to read the IF flag. Indirect update instructions also check the serializing scoreboard. In addition, these instructions set the serializing scoreboard at rename time and clear this scoreboard when updating the IF value in the renamer at retirement. The scoreboard algorithm can prevent RAW (read after write) and WAW (write after write) stall hazards.

Under an embodiment of the invention, recovery is provided from incorrect speculation such as branch mis-prediction. According to one embodiment, the recovery is provided by shadow logic. A process of flag value renaming has two different modes, comprising writes from direct instructions and writes from indirect instructions. In order to handle the two different modes, a valid bit may be added to the shadow logic to indicate the validity of data. The valid bit enables shadowing for direct instructions and disables it for indirect instructions. Shadowing is disabled for indirect instructions because such instructions do not update the values in the renamer until retirement, and thus the values in the renamer should not be utilized.

An embodiment of the invention may reduce serialization penalties that occur if flags are not renamed. The embodiment may operate with relatively minimal hardware, such as data flops and decode logic in the renamer, additional bits in the shadow logic array, and additional data bits and control logic in the ROB. The embodiment may require less hardware than if flags are fully renamed, which may require components such as specific rename registers and register pointers.

An embodiment of the invention may execute direct update instructions at the renamer, and thus it is not necessary to send the instructions to the ALU (arithmetic logic unit) of the processor, thereby improving system performance. In comparison with full renaming, an embodiment may provide better speed of operation because of reduction in the number of instructions that are executed in the ALU.

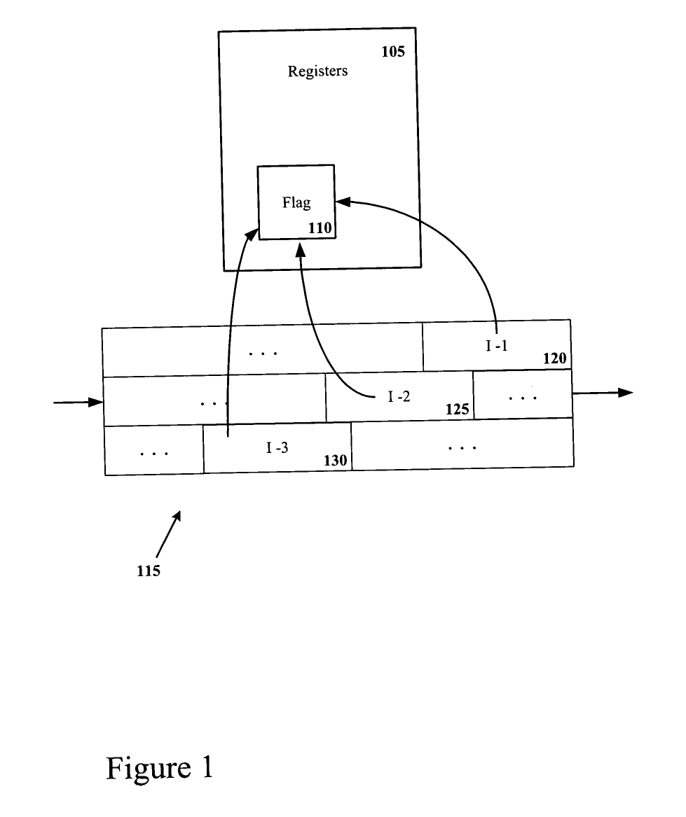

FIG. 1 illustrates an embodiment of a set of registers 105 including a flag 110. In this illustration, an instruction pipeline 115 includes parallel execution of instructions. The instructions include a first instruction (I-1) 120, a second instruction (I-2) 125, and a third instruction (I-3) 130. In the example, each of the instructions is seeking to write to the flag 110. The instructions may include direct update instruction and indirect update instructions. Under an embodiment of the invention, succeeding instructions are only stalled when the value of the flag is not known. In this example, if a prior instruction is a direct update instruction, the value of the flag is known and succeeding instructions are not stalled. If a prior instruction is an indirect update instruction, the value of the flag may not be known and succeeding instructions may be stalled until completion of the prior instruction.

For example, if the first instruction 120 is a direct update instruction, then the second instruction 125 is not stalled. However, if second instruction 125 is an indirect update instruction and thus the value of flag 110 is not known, then the third instruction 130 may be stalled until the completion of the second instruction 125.

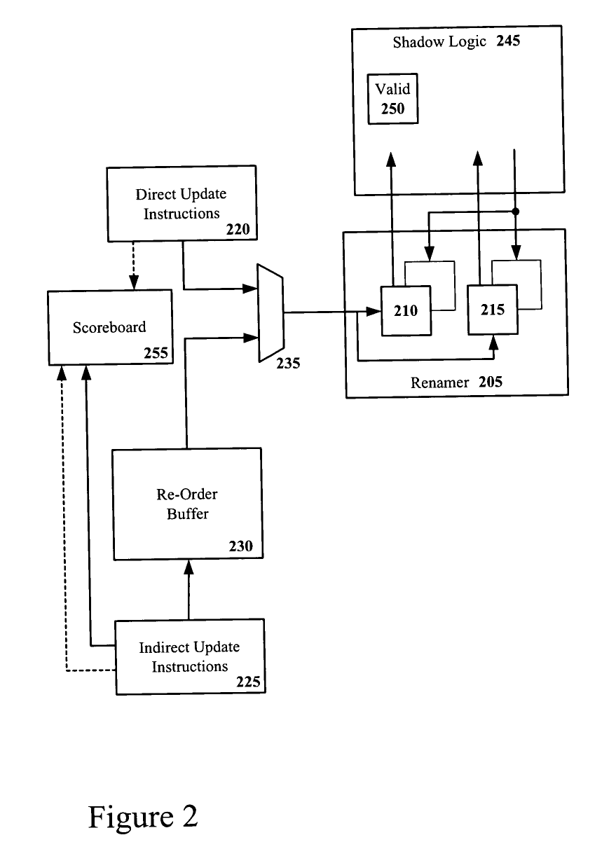

FIG. 2 illustrates an embodiment of a renaming architecture. FIG. 2 illustrates the operation of the embodiment, and is not intended to illustrate physical structure. In the illustrated embodiment, a renamer 205 is utilized to rename registers, including a first flag 210 and a second flag 215. The flags may include, but are not limited to, an interrupt flag (IF) and a direction flag (DF). The flags may be set by varied instructions, including direct update instructions 220 and indirect update instructions 225. A multiplexer 235 is shown to illustrate the choice between the different types of instructions.

To write to one of the flags, a direct update instruction 220 will check a scoreboard 255 to determine whether the flag is in use. If the scoreboard 255 indicates that the flag is in use, the instruction will stall. If the scoreboard 255 indicates that the flag is not in use, the direct update instruction 220 writes the value for the flag to the renamer 205.

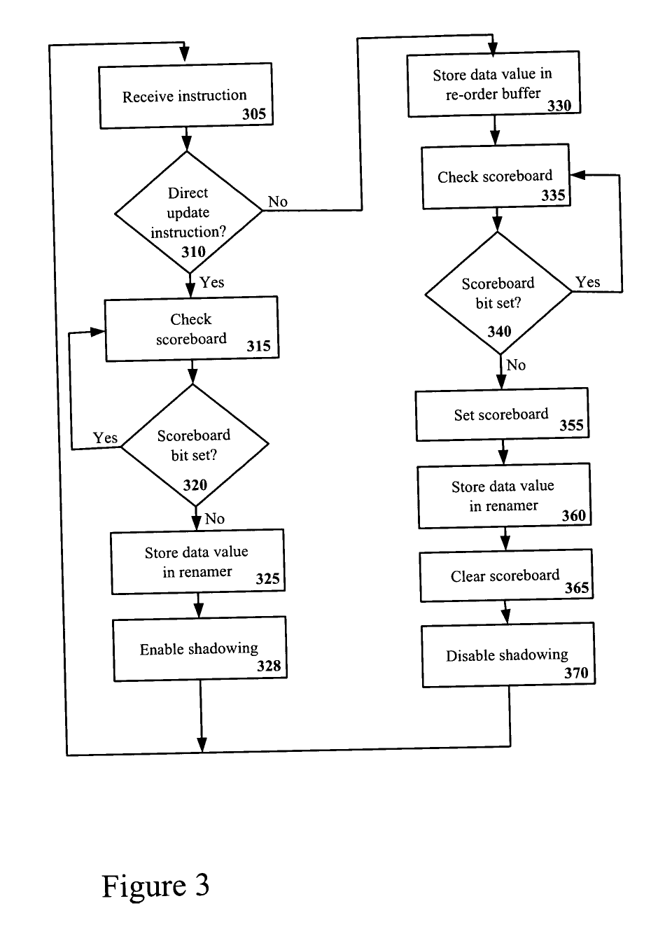

In the embodiment shown in FIG. 3, an indirect update instruction 225 will store the data value in a re-order buffer 230. The indirect update instruction 225 will also check the scoreboard 255 to determine whether the flag is available. If the flag is available, the indirect update instruction 225 will set the scoreboard 255 to prevent access by any other instruction. At retirement, the data value for the flag provided by the indirect update instruction 225 is stored to the renamer 205 for the flag. The scoreboard 255 then is cleared to allow access to the flag by other instructions.

In addition, shadow logic 245 may store values of the flags 210 and 215 to record prior values of the flags. However, an indirect update instruction 225 does not update values until retirement and thus should not be shadowed. A valid bit 250 is included in the shadow logic 245. The valid bit 250 is enabled for direct update instructions 220 and is disabled for indirect update instructions 225.

FIG. 3 is a flowchart of an embodiment of the invention. In this illustration, an instruction is received. If the instruction is a direct update instruction 310, the instruction checks a register scoreboard 315. If the scoreboard bit for the register is set-320, indicating that another instruction is utilizing the register, there is a delay and the instruction continues to check the scoreboard 315. When the scoreboard is no longer set 320, the instruction sets the data value in the renamer 325. The shadowing of the register value is then enabled 328 by setting a bit in the shadow logic.

If the instruction is not a direct update instruction 310, and thus is an indirect update instruction, the data value for the register is stored in a re-order buffer 330. When the instruction is being retired 335, the instruction checks to determine whether the scoreboard bit for the flag is set 340. If the scoreboard is set 345, the instruction delays and continues to check the scoreboard 340. When the flag is no longer set 345, the instruction sets the scoreboard bit 350 to prevent access to the register before the value is provided to the renamer. When the instruction is retired 355, the data value is stored in the renamer 360. When the data value has been stored, the scoreboard bit for the register is cleared 365 to allow access to the register. The shadowing of the register value is then disabled 370. The process continues with succeeding instructions. Multiple instructions in a pipeline may be processed simultaneously in the manner shown in FIG. 3.

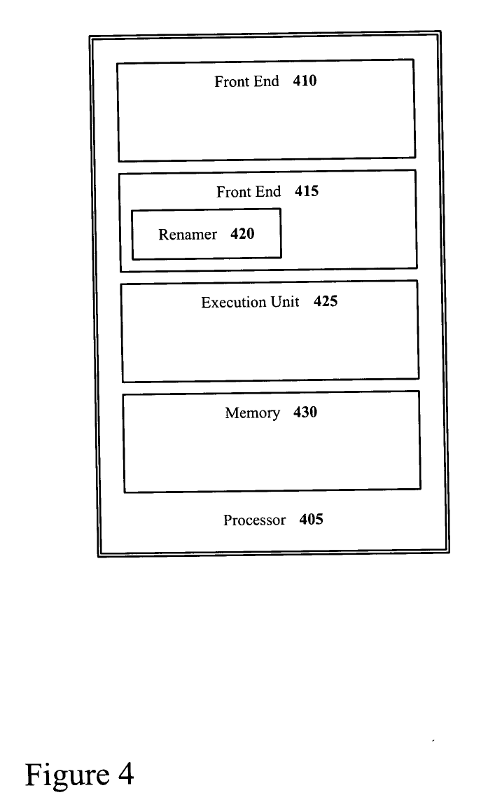

FIG. 4 illustrates an embodiment of a processor. The illustration is a simplified drawing and does not include all elements of the processor. In this illustration, the microprocessor 405 includes a front end section 410, execution logic 415, an execution unit 425, and memory 430. The execution logic 415 includes a renamer 420. The memory 430 may include one or more cache memories. The processor 405 processes various instructions, including direct update instructions and indirect update instructions. The renamer 420 is used to handle the different types of instructions. In this embodiment, a direct update instruction that writes to a flag for the processor 405 does not cause stalling of a succeeding instruction that addresses the same flag. However, an indirect update instruction that writes to the flag may cause stalling of a succeeding instruction that writes to the same flag because the value of the flag isn't known until the indirect update instruction is retired.

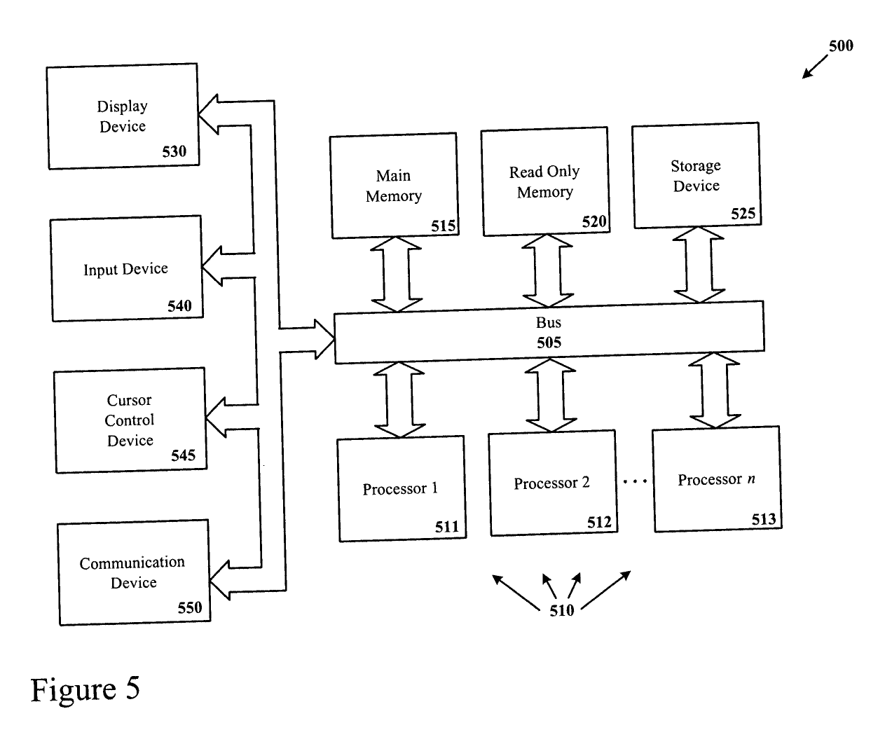

Techniques described here may be used in many different environments. FIG. 5 is block diagram of an embodiment of an exemplary computer. Under an embodiment of the invention, a computer 500 comprises a bus 505 or other communication means for communicating information, and a processing means such as one or more physical processors 510 (shown as 511, 512 and continuing through 513) coupled with the first bus 505 for processing information. Each of the physical processors may include multiple logical processors, and the logical processors may operate in parallel. According to an embodiment of the invention, a processor includes a renamer to rename registers.

The computer 500 further comprises a random access memory (RAM) or other dynamic storage device as a main memory 515 for storing information and instructions to be executed by the processors 510. Main memory 515 also may be used for storing temporary variables or other intermediate information during execution of instructions by the processors 510. The computer 500 also may comprise a read only memory (ROM) 520 and/or other static storage device for storing static information and instructions for the processor 510.

A data storage device 525 may also be coupled to the bus 505 of the computer 500 for storing information and instructions. The data storage device 525 may include a magnetic disk or optical disc and its corresponding drive, flash memory or other nonvolatile memory, or other memory device. Such elements may be combined together or may be separate components, and utilize parts of other elements of the computer 500.

The computer 500 may also be coupled via the bus 505 to a display device 530, such as a liquid crystal display (LCD) or other display technology, for displaying information to an end user. In some environments, the display device may be a touch-screen that is also utilized as at least a part of an input device. In some environments, display device 530 may be or may include an auditory device, such as a speaker for providing auditory information. An input device 540 may be coupled to the bus 505 for communicating information and/or command selections to the processor 510. In various implementations, input device 540 may be a keyboard, a keypad, a touch-screen and stylus, a voice-activated system, or other input device, or combinations of such devices. Another type of user input device that may be included is a cursor control device 545, such as a mouse, a trackball, or cursor direction keys for communicating direction information and command selections to processor 510 and for controlling cursor movement on display device 530.

A communication device 550 may also be coupled to the bus 505. Depending upon the particular implementation, the communication device 550 may include a transceiver, a wireless modem, a network interface card, or other interface device. The computer 500 may be linked to a network or to other devices using the communication device 550, which may include links to the Internet, a local area network, or another environment.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

1. A method comprising:
setting a flag for a processor via a first instruction, the first instruction being either a direct update instruction or an indirect update instruction;
if the setting of the flag is by a direct update instruction, executing a succeeding second instruction that reads the flag prior to completion of the first instruction; and
if the setting of the flag is by an indirect update instruction, delaying the second instruction until after completion of the first instruction.

2. The method of claim 1, wherein setting the flag by a direct update instruction comprises storing a value for the flag in a renamer.

3. The method of claim 2, wherein setting the flag by an indirect update instruction comprises storing a value in a buffer and storing the value in the renamer upon retirement of the indirect update instruction.

4. The method of claim 3, further comprising checking the value of a register scoreboard prior to accessing the flag.

5. The method of claim 4, wherein executing an indirect update instruction comprises setting the register scoreboard prior to storing the value in the renamer and clearing the register scoreboard after storing the value in the renamer.

6. The method of claim 1, further comprising storing the value for the flag in shadow logic.

7. The method of claim 6, wherein the shadow logic is enabled if the value was provided by a direct update instruction.

8. The method of claim 7, wherein the shadow logic is disabled if the value was provided by a direct update instruction.

9. A processor comprising:
an execution unit to execute instructions; and
a renamer, the renamer to rename a flag register and store the value for the flag register;
the value of the flag register being set by one of a plurality of processes, the processes including directly setting the flag register by a first instruction or setting the flag register to an data value obtained by a second instruction; and
a succeeding third instruction being executed without being stalled if the value of the flag register was set by the first instruction and being stalled until conclusion of the second instruction if the value of the flag register is set by the second instruction.

10. The processor of claim 9, further comprising a scoreboard register, the first instruction and the second instruction checking the scoreboard register before setting the flag register.

11. The processor of claim 10, wherein the first instruction and the second instruction delay storage of the flag register if the scoreboard register is enabled.

12. The processor of claim 11, wherein execution of the second instruction includes setting the scoreboard register before setting the flag register and clearing the scoreboard register after setting the flag register.

13. The processor of claim 9, further comprising shadow logic to store values for the flag register.

14. The processor of claim 13, wherein the shadow logic includes a validity register to indicate validity of stored values for the flag register.

15. The processor of claim 14, wherein the validity register is enabled if a value for the flag register is provided by the first instruction and the validity register is disabled if the value for the flag register is provided by the second instruction.

16. The processor of claim 9, wherein the flag register is one of an interrupt flag or a direction flag.

17. The processor of claim 16, wherein the first instruction is an instruction to set or clear the flag register.

18. The processor of claim 9, wherein the second instruction is an instruction to pop a data value from a memory stack.

19. A system comprising:
a bus;
a flash memory coupled to the bus; and
a processor coupled to the bus, the processor comprising:
an execution unit to execute instructions; and
a renamer, the renamer to rename a flag register and store the value for the flag register;
the value of the flag register being set by one of a plurality of processes, the processes including directly setting the flag register by a first instruction or setting the flag register to an data value obtained by a second instruction; and
a succeeding third instruction being executed without being stalled if the value of the flag register was set by the first instruction and being stalled until conclusion of the second instruction if the value of the flag register is set by the second instruction.

20. The system of claim 19, wherein the processor further comprises a scoreboard register, the first instruction and the second instruction checking the scoreboard register before setting the flag register.

21. The system of claim 20, wherein the first instruction and the second instruction delay storage of the flag register if the scoreboard register is enabled.

22. The system of claim 21, wherein execution of the second instruction includes setting the scoreboard register before setting the flag register and clearing the scoreboard register after setting the flag register.

23. The system of claim 19, wherein the processor further comprises shadow logic to store values for the flag register.

24. The system of claim 23, wherein the shadow logic includes a validity register to indicate validity of stored values for the flag register.

25. The system of claim 24, wherein the validity register is enabled if a value for the flag register is provided by the first instruction and the validity register is disabled if the value for the flag register is provided by the second instruction.

26. The system of claim 19, wherein the flag register is one of an interrupt flag or a direction flag.

27. The system of claim 26, wherein the first instruction is an instruction to set or clear the flag register.

28. The system of claim 19, wherein the second instruction is an instruction to pop a data value from a memory stack.
